(19) United States
(12) Patent Application Publication
(10) Pub. No.: US 2008/0096674 A1
(43) Pub. Date: Apr. 24, 2008

(54) Drive Train for Vehicles

(75) Inventors: Eckard Pueschel, Marzling (DE); Michael Berger, Muenchen (DE); Jens Vorwerk, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/945,628

(22) Filed: Nov. 27, 2007

Related U.S. Application Data
(63) Continuation of application No. PCT/EP2006/006807, filed on Jul. 12, 2006.

(30) Foreign Application Priority Data
Aug. 8, 2005 (DE) 10 2005 037 379.8
Oct. 21, 2005 (DE) 10 2005 050 506.6

(51) Int. Cl. F16D 3/00

(52) U.S. Cl. 464/98

(57) ABSTRACT

A drive train for vehicles is provided, having an internal-combustion engine, to which a flange of a transmission housing is flangedly connected. A crankshaft of the internal-combustion engine is connected by way of an intermediate element with a drive flange of a torque converter of the transmission arranged in the area of the flange. The drive flange of the torque converter is screwed to the intermediate element via several connecting screws arranged in a distributed manner along a circumference of the intermediate element. Viewed from the transmission in the direction of the internal-combustion engine, the connecting screws are screwed at an angle diagonally toward the interior into the intermediate element. The intermediate element has a central part, which is made of spring steel, is elastic in the manner of a cup spring, and has several radially projecting spring arms.

### CROSS-REFERENCE TO RELATED APPLICATIONS

This application is a continuation of PCT International Application No. PCT/EP2006/006807, filed on Jul. 12, 2006, which claims priority under 35 U.S.C. § 119 to German Application Nos. 10 2005 037 379.8, filed Aug. 8, 2005 and 10 2005 050 506.6, filed Oct. 21, 2005, the entire disclosures of which are expressly incorporated by reference herein.

### BACKGROUND AND SUMMARY OF THE INVENTION

The present invention relates to a drive train for vehicles, having an internal-combustion engine to which a flange of a transmission housing is flangedly connected. A crankshaft of the internal-combustion engine is connected by way of an intermediate element to a drive flange of a torque converter of the transmission arranged in the area of the flange. The drive flange of the torque converter is connected with the intermediate element by way of several connecting screws arranged in a distributed manner along a circumference of the intermediate element, viewed from the transmission in the direction of the internal-combustion engine. The connecting screws are screwed into the intermediate element at an angle diagonally toward the interior.

A drive train of the above-mentioned type is known from European Patent document EP 1 347 210 B1. There, the output-side end of the crankshaft is screwed to a drive flange of a torque converter by way of a driving disk. The driving disk is a rotationally symmetrical pressed sheet metal part. It is made of deep-drawn sheet steel. The radial edge of the driving disk is bent over in a manner similar to the edge of a bowl. The connecting screws, by which the converter is screwed to the driving disk, are arranged diagonally with respect to the crankshaft axis, which facilitates mounting and demounting.

During operation, axial “displacements” occur in the transmission line. On the one hand, axial displacements are the result of thermal expansions of the crankshaft. On the other hand, displacements originate from the torque converter. During the transition from an idling operation to a load operation, an operating oil pressure builds up in the converter, by which the drive flange of the torque converter is pressed in the direction of the internal-combustion engine.

The present invention provides a drive train for vehicles which is very mounting-friendly and demounting-friendly and where the axial displacements occurring during operation are compensated in a constructively simple manner.

The invention provides a drive train for vehicles, having an internal-combustion to which a flange of a transmission housing is flangedly connected. A crankshaft of the internal-combustion engine is connected with a drive flange of a torque converter by way of a cup-spring-type intermediate element, which is elastic in an axial direction. The torque converter is arranged in the area of the transmission input or of the flange of the transmission. The drive flange of the torque converter is screwed to the intermediate element by way of several connecting screws arranged in a distributed manner along a circumference of the intermediate element. In order to permit easy mounting and demounting, the drive flange of the torque converter is screwed to the intermediate element from the side of the transmission housing, specifically such that the connecting screws are screwed from the transmission, viewed in the direction of the internal-combustion engine, at an angle diagonally toward the interior, into the intermediate element. The intermediate element provided for the torque transmission from the crankshaft to the drive flange of the torque converter has a central part, which is produced from a spring steel sheet, is elastic in the fashion of a cup spring, and has several radially outwardly projecting spring arms. The central part may essentially be flat. The free ends of the spring arms are indirectly connected with the drive flange of the torque converter. The central part of the intermediate element made of spring steel provides the transmission line with the axial elasticity which is required for compensating the axial displacements occurring during operation.

For connecting the intermediate element with the drive flange of the torque converter, a flange ring may be provided, which is connected with the free ends of the spring arms. The free ends of the spring arms may be riveted or otherwise connected to the flange ring. “Flange elements”, into which the connecting screws are screwed, are arranged in a distributed manner along the circumference of the flange ring. The flange elements may be shaped-out sections of the flange ring and thus an integral component of the flange ring.

As an alternative to a flange ring, a separate flange element may be arranged in each case at the free ends of the spring arms. The flange elements may be riveted to the spring arms. The flange elements are constructed such that threaded boreholes provided therein, into which the connecting screws are screwed, correspondingly point diagonally toward the interior.

The flange ring or, as an alternative thereto, the flange elements, are preferably not made of spring steel like the central part, but rather are made of a steel which can be easily deformed or deep drawn.

For mounting or demounting of the connecting screws, a mounting opening can be provided in the transmission housing. In the case of a corresponding rotational position of the intermediate element and of the torque converter, one or more of the connecting screws are accessible from the exterior side of the transmission housing by way of the mounting opening. As a result of the continued rotation of the engine or of the intermediate element connected with the crankshaft of the engine, the other connecting screws are also successively accessible diagonally from the outside.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic representation of the basic principle of the invention;

FIG. 2 is a schematic representation of the mounting opening prior to securing a connecting screw;

FIG. 3 is an exemplary embodiment of a cup-spring-type intermediate element;

FIG. 4 is another exemplary embodiment of a cup-spring-type intermediate element;

FIG. 5 is a schematic representation of another embodiment of an intermediate element;

FIG. 6 is a schematic representation of yet another embodiment of the invention;

FIG. 7 is a rear view from the transmission direction of the embodiment of FIG. 6; and

FIG. 8 is a lateral section view of the embodiment of FIG. 6.

### DETAILED DESCRIPTION OF THE DRAWINGS

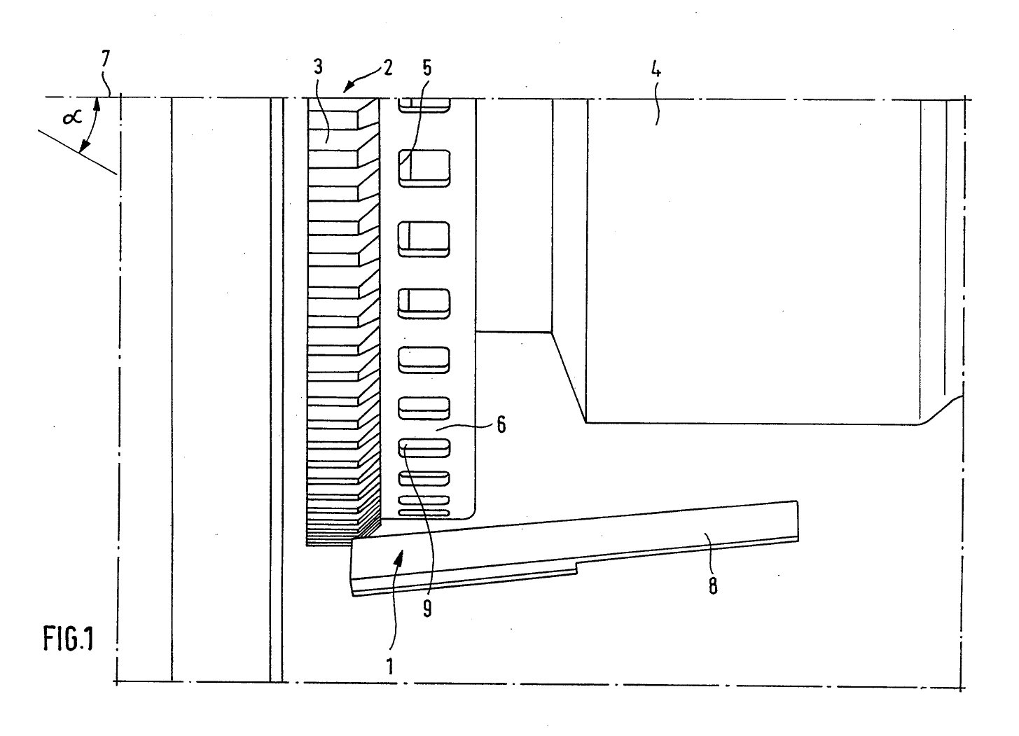

FIG. 1 is a schematic representation of the basic principle of the invention. A transmission housing is flangedly connected to the internal-combustion engine (not shown here in detail). Only one wall section 1 of the transmission housing is illustrated here. A crankshaft of the internal-combustion engine (not illustrated here in detail) is connected with an “intermediate element” 2. A starting ring gear 3 is provided on the exterior side of the intermediate element 2, into which starting ring gear 3, the starter pinion of a starter (not shown here in detail) can be engaged.

In the transmission housing 1, a torque converter 4 is provided, which has a drive flange 5 screwed to the intermediate element 2. By way of several connecting screws arranged in a distributed manner in the circumferential direction of the intermediate element 2, the drive flange 5 is screwed to the intermediate element 2.

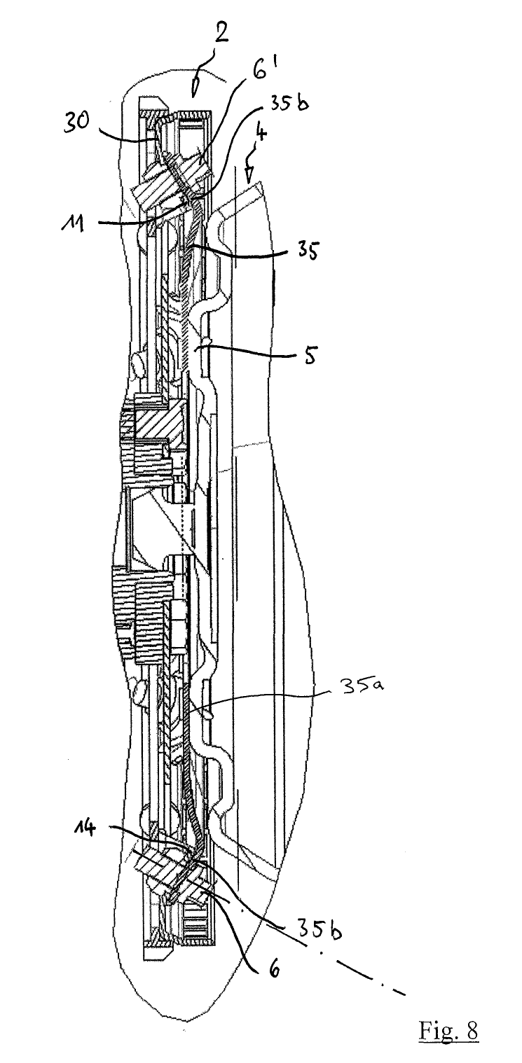

It is explicitly pointed out that the drive flange 5 does not necessarily have to be screwed directly to the intermediate element 2, which will be explained in detail in connection with FIG. 8.

Of the connecting screws, FIG. 1 shows only one connecting screw 6. As illustrated in FIG. 1, the connecting screw 6 is arranged diagonally with respect to an axial direction 7. Viewed from the transmission in the direction of the internal-combustion engine, the connecting screw 6 is screwed into the intermediate element 2 at an angle α diagonally toward the interior. The angle α may be, for example, 30°.

A mounting opening 8 for mounting or demounting of the t connecting screws 6 is provided in the transmission housing 1. By way of the mounting opening 8, the screw may be introduced diagonally toward the interior by use of a corresponding mounting tool, such as a socket, and can be screwed into the intermediate element 2.

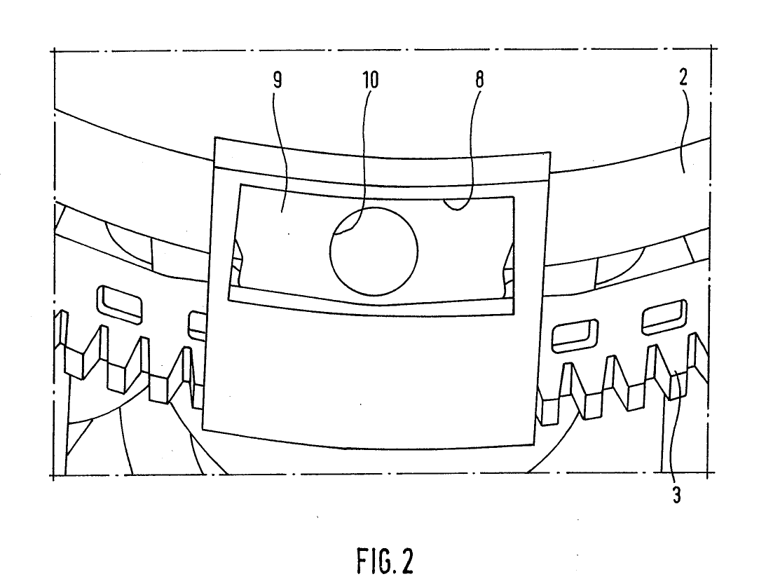

FIG. 2 shows the mounting opening 8 before screwing-in of a connecting screw 6. As illustrated in FIG. 2, a diagonally arranged flange element 9 is provided on the outer circumference of the intermediate element 2. The flange element 9 has a threaded borehole 10, into which the connecting screw 6 (compare FIG. 1) can be screwed.

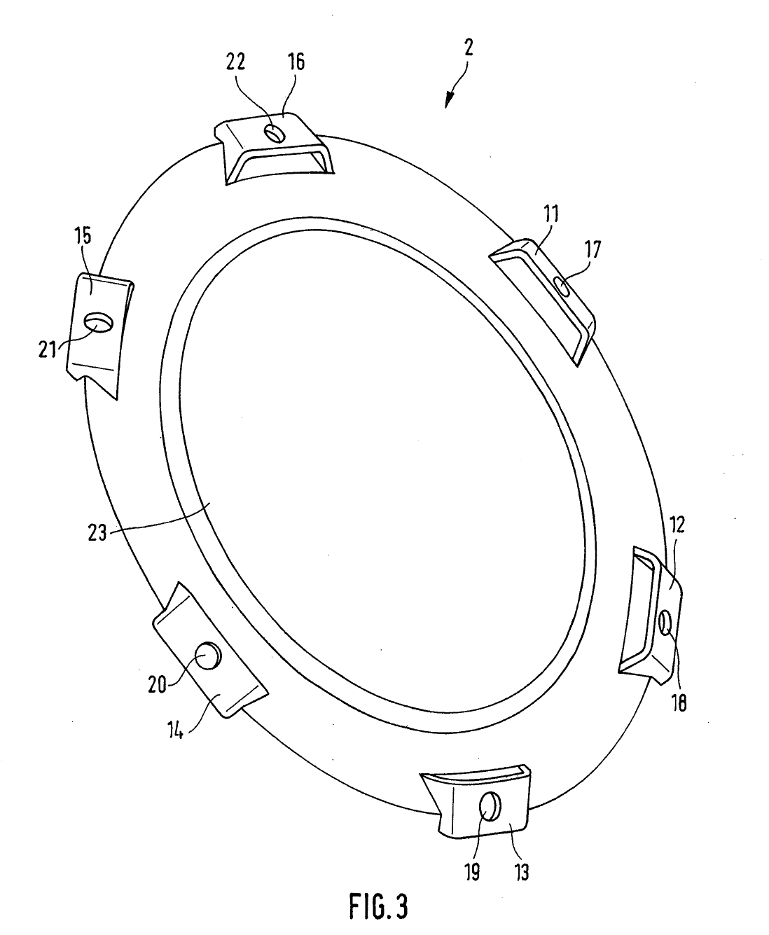

FIG. 3 shows an embodiment of a cup-spring-type intermediate element 2, at whose outer circumference several flange elements 11-16 are arranged in a distributed manner. Each of the flange elements 11-16 has one threaded borehole 17-22, respectively. The flange elements 11-16 are an integral component of the cup-spring-type intermediate element 2. As an alternative, the flange elements 11-16 may also be made of a different material than that of the “central part” 23 of the cup-spring-type intermediate element 2. The flange elements 11-16 may, for example, be riveted to the central part 23.

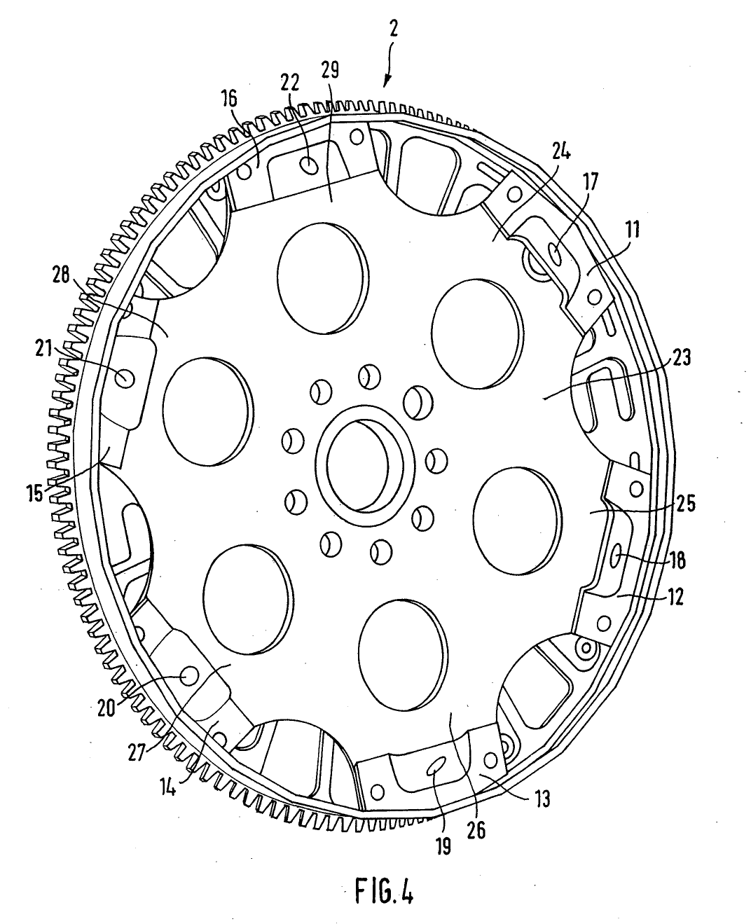

FIG. 4 shows another embodiment of a cup-spring-type intermediate element 2. The intermediate element 2 has a central part 23 which is made of a spring steel sheet. The central part 23 also has spring arms 24-29, which project radially toward the outside. One flange element 11-16, respectively, is arranged at free ends of the spring arms. The flange elements 11-16 may be riveted to the central part or, more precisely, to the arms 24-29 of the central part 23. As illustrated in FIG. 4, the flange elements 11-16 each have a threaded borehole 17-22. The threaded boreholes are each provided in a bulge of the flange elements 11-16. As explained in connection with FIG. 1, the longitudinal axes of the threaded boreholes 17-22 extend diagonally toward the interior; for example, at a 30° angle with respect to the axis of rotation of the intermediate element 2.

Since, in the embodiment of FIG. 4, the flange elements 11-16 are made of a different material than that of the central part 23, the “elasticity in the axial direction” function and the “connection with the drive flange of the torque converter” function are performed by different components having respectively different characteristics of their material. While the central part is preferably produced from a spring steel sheet, the flange elements 11-16 may be made of a deep-drawn steel sheet.

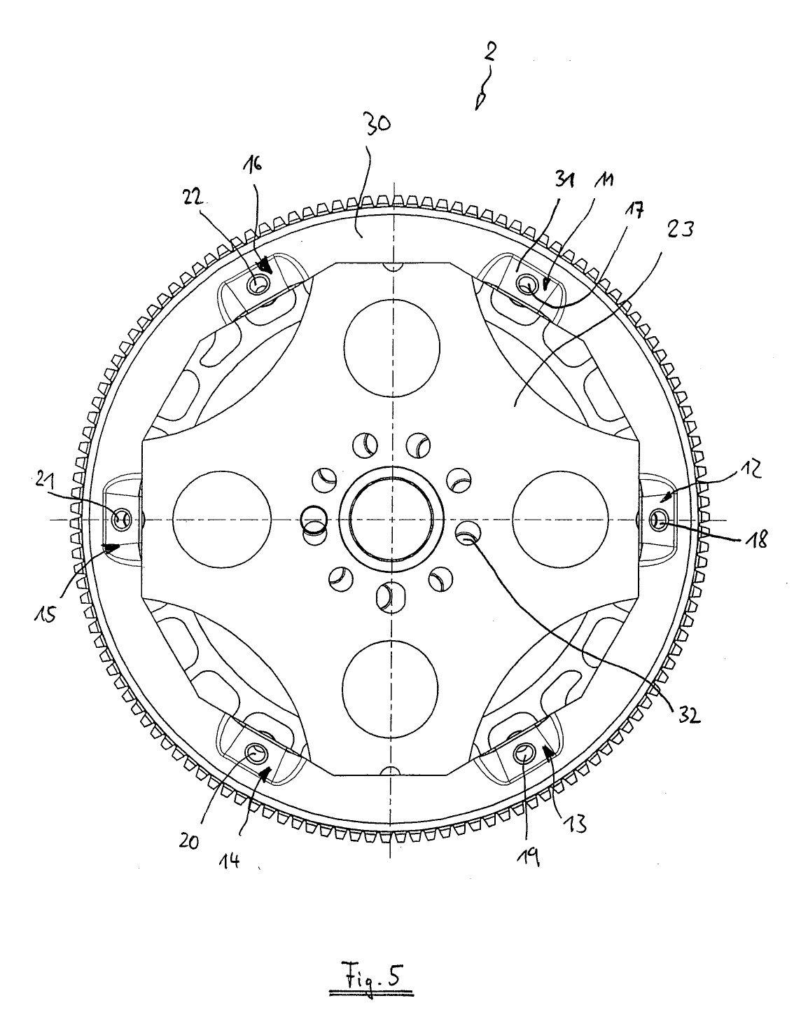

FIG. 5 shows another embodiment of an intermediate element 2 according to the invention. The intermediate element 2 of FIG. 5 has a four-armed central part 23. The free ends of the central part 23, which may also be produced of spring steel, are connected with a flange ring 30. The flange ring 30 and the central part 23 may, for example, be riveted to one another. The flange ring 30 may be made of deep-drawn steel plate. Several flange elements 11-16 are arranged in the circumferential direction of the flange ring 30. The flange elements 11-16 are formed by shaped-out sections in the flange ring 30 which can be produced, for example, by deep drawing. Each of the shaped-out sections has a surface 31 disposed diagonally with respect to an axis of rotation of the intermediate element 2. One threaded borehole 17-22, respectively, is provided in these diagonal surfaces, into which threaded boreholes 17-22 the connecting screws are screwed.

For connecting the intermediate element 2 with the crankshaft, several boreholes 32 are provided in the central area of the intermediate element 2 in a circumferentially distributed manner, by which boreholes 32 the crankshaft can be flanged to the intermediate element 2.

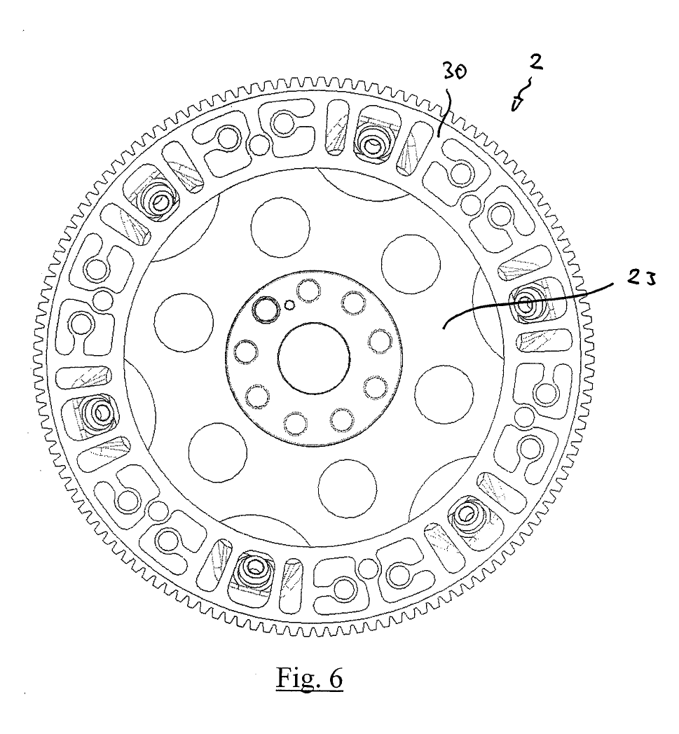

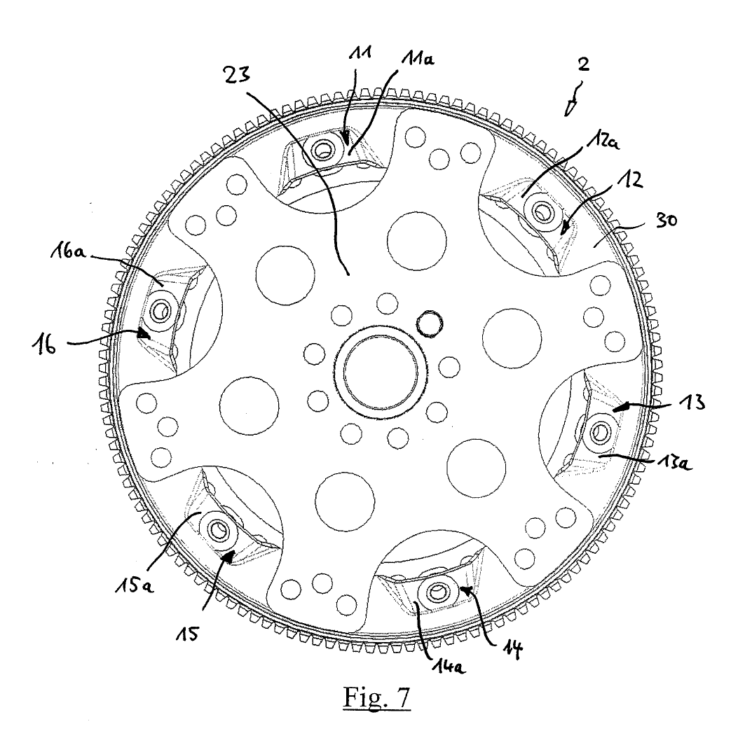

FIG. 6 illustrates another embodiment according to the invention viewed from the side of the engine or from the side of the crankshaft. FIG. 7 is its rear view; that is, viewed from the transmission. FIG. 8 is a lateral sectional view.

The intermediate element 2 of FIGS. 6-8 has a central part 23 with six spring arms evenly spaced from one another in the circumferential direction. Viewed from the side of the transmission (see FIG. 7), the central part 23 with its spring arms is placed onto the flange ring 30. The ends of the spring arms are riveted to the flange ring 30 in a manner similar to that of the embodiment of FIG. 4. As outlined in FIG. 7, the flange elements 11-16 have convex flange surfaces 11a-16a. In the embodiment illustrated here, the flange surfaces 11a-16a have a spherical design. This means that the flange surfaces 11a-16a of the six flange elements 11-16 are all situated on an imaginary sphere.

FIG. 8 is a lateral sectional view of the intermediate element 2 of FIGS. 6, 7. FIG. 8 shows that the drive flange 5 of the torque converter 4 is not screwed directly to the intermediate element 2 but rather by way of a ring-type intermediate metal sheet 35. A radially interior section 35a of the intermediate metal sheet 35 is connected with the drive flange 5 of the torque converter 4. The drive flange 5 may be riveted, screwed, welded or otherwise connected to the intermediate metal sheet 35. A radially exterior section 35b of the intermediate metal sheet is spherically bent and rests on the flange surfaces 11a-16a of the six flange elements, of which only the flange elements 11 and 14 are visible in FIG. 8. At the flange elements 11-16, the intermediate metal sheet 35 is screwed to the flange ring 30. As already explained in connection with FIG. 1, viewed from the side of the torque converter 4, the screws 6, 6′ are “screwed in diagonally toward the interior”.

As an alternative to the intermediate metal sheet 35, angle elements or the like may also be screwed or riveted to the drive flange 5, which angle elements or the like rest on the flange surfaces 11a-16a and are screwed to the flange ring 30.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A drive train for a vehicle having an internal combustion engine to which a housing flange of a transmission is flangedly-connected, the drive train comprising:
a torque converter having a drive flange, the torque converter being arranged in a region of the housing flange;
a crankshaft of the internal-combustion engine;
an intermediate element by which the crankshaft of the internal combustion engine is connected to the drive flange of the torque converter via a plurality of connecting screws arranged in a distributed manner about a circumference of the intermediate element;
wherein, viewed from a direction of the transmission toward the internal-combustion engine, the connecting screws are screwed at an angle diagonally inwardly into the intermediate element; and
wherein the intermediate element includes a central part made of spring steel, is elastic in a cup-spring-type manner, and comprises a plurality of radially projecting spring arms.

2. The drive train according to claim 1, further comprising a flange ring having several flange elements arranged in a distributed manner about a circumference of the flange ring, the flange ring being connected with free ends of the plurality of spring arms; and
wherein the plurality of connecting screws are screwed into the flange elements into the intermediate element.

3. The drive train according to claim 2, wherein the flange elements are integrally formed by shaping-out sections of the flange ring.

4. The drive train according to claim 1, further comprising flange elements, one flange element being respectively arranged at each free end of the radially projecting spring arms, wherein a connecting screw is respectively screwed into the flange element.

5. The drive train according to claim 4, wherein the flange elements are made of deep-drawn steel sheet.

6. The drive train according to claim 1, further comprising a mounting opening formed in the housing of the transmission, the mounting opening accessing the connecting screws from an exterior side of the transmission housing in accordance with corresponding rotational positions of the intermediate element and the torque converter.

7. The drive train according to claim 2, further comprising a mounting opening formed in the housing of the transmission, the mounting opening accessing the connecting screws from an exterior side of the transmission housing in accordance with corresponding rotational positions of the intermediate element and the torque converter.

8. The drive train according to claim 3, further comprising a mounting opening formed in the housing of the transmission, the mounting opening accessing the connecting screws from an exterior side of the transmission housing in accordance with corresponding rotational positions of the intermediate element and the torque converter.

9. The drive train according to claim 4, further comprising a mounting opening formed in the housing of the transmission, the mounting opening accessing the connecting screws from an exterior side of the transmission housing in accordance with corresponding rotational positions of the intermediate element and the torque converter.

10. The drive train according to claim 5, further comprising a mounting opening formed in the housing of the transmission, the mounting opening accessing the connecting screws from an exterior side of the transmission housing in accordance with corresponding rotational positions of the intermediate element and the torque converter.

11. The drive train according to claim 2, wherein the flange elements have spherically curved flange surfaces, the drive flange of the torque converter or a component connected with the drive flange of the torque converter resting directly on the flange surfaces.

12. The drive train according to claim 3, wherein the flange elements have spherically curved flange surfaces, the drive flange of the torque converter or a component connected with the drive flange of the torque converter resting directly on the flange surfaces.

13. The drive train according to claim 4, wherein the flange elements have spherically curved flange surfaces, the drive flange of the torque converter or a component connected with the drive flange of the torque converter resting directly on the flange surfaces.

14. The drive train according to claim 2, wherein, viewed from a side of the transmission housing, the plurality of spring arms of the central part rest on the flange ring.

15. The drive train according to claim 3, wherein, viewed from a side of the transmission housing, the plurality of spring arms of the central part rest on the flange ring.

16. A drive train component for a vehicle having an internal combustion engine to which a flange of a transmission housing is flangedly-connected, the drive train component connecting a crankshaft of the engine to a drive flange of a torque converter, the drive train component comprising:
an intermediate element having a central part made of spring steel and being elastic in a cup-spring-type manner;
wherein a plurality of spring arms project radially from the central part of the intermediate element; and
each of the plurality of projecting spring arms comprising a screw bore extending obliquely inwardly and being operatively configured to provide a screwed connection between the drive flange of the torque converter and the crankshaft of the engine.

17. The drive train component according to claim 16, further comprising a flange ring connected with free ends of the plurality of spring arms, wherein a plurality of flange elements are arranged in a distributed manner about a circumference of the flange ring, the flange elements including a portion of the screw bores.

18. The driver train component according to claim 16, further comprising a plurality of flange elements, one flange element being respectively at each free end of the radially projecting spring arms, the flange element including a portion of the screw bores.
